(19) United States
(12) Patent Application Publication
(10) Pub. No.: US 2015/0108684 A1
(43) Pub. Date: Apr. 23, 2015

(54) MOLD ASSEMBLY FOR MAKING A BOTTOM END CAP IN A PLEATED FILTER CARTRIDGE AND RELATED METHOD

(71) Applicant: General Electric Company, Schenectady, NY (US)

(72) Inventors: Jeffrey Allen CANFIELD, Belton, MO (US); Alfred Kam Wing LO, Overland Park, KS (US)

(73) Assignee: General Electric Company, Schenectady, NY (US)

(21) Appl. No.: 14/061,513

(22) Filed: Oct. 23, 2013

(51) Int. Cl. B01D 27/08; B29C 70/76

(52) U.S. Cl. CPC B01D 27/08; B29C 70/766
USPC 264/259; 425/500

(57) ABSTRACT

A mold assembly for forming a bottom end cap in a pleated filter cartridge includes a master mold component having a cup-shaped body including a bottom wall and an annular peripheral wall, an interior surface of the bottom wall having a radially outward portion tapered upwardly in a radial inward direction and a flat center section. An associated sleeve component includes a peripheral side wall and a bottom wall shaped to fit within the master mold component, an exterior surface of the bottom wall having a taper complementary to the radially outward tapered portion of the master mold component and a center opening alignable with the flat center section of the master mold component.

### BACKGROUND OF THE INVENTION

The subject matter disclosed herein relates to a mold assembly for making a pleated filter cartridge and more specifically, to a mold assembly for forming a bottom end cap integrated with the lower end of the pleated filter.

Conventional pleated filter cartridges include a pleated filter disposed between two molded end caps (i.e., a top end cap and bottom end cap). Pleated filter cartridges are used in a variety of applications including removing particulates from gases in the food, pharmaceutical, and energy industries. During use, a gas (e.g. air) is passed through the filter media of the pleated filter to trap particulates that may be present (e.g. ambient dust, milk dust, coal dust, pollen, microorganisms including yeast, mold and bacteria). Initially, these particulates are entrapped on the surface of the pleated filter. Over time, and particularly when the filter cartridge is vertically oriented, the particulates may accumulate on a horizontally extending ledge of the molded bottom end cap. This accumulation can result either from particulate drift due to gravity or from the entrapped particles being dislodged during pulse-jet cleaning of the filter. In certain applications, particulate accumulation on the horizontally extending ledge of the molded bottom end cap can impact the efficacy of the filtering process by reducing the available filtering area, or by increasing the risk of contamination and possibly combustion.

It is difficult to produce quality pleated filter cartridges that do not have a horizontally extending ledge on their molded bottom end cap. The prior art methods for producing such cartridges use two-part epoxy resins that have certain manufacturing challenges associated with them that inhibit their use on a commercial scale.

There is a continuing need, therefore, to provide an improved mold assembly and related method for rapidly making pleated filter cartridges with bottom end caps that do not have a horizontally extending ledge.

### BRIEF DESCRIPTION OF THE INVENTION

In one exemplary but nonlimiting embodiment, there is provided a mold assembly for forming a bottom end cap in a pleated filter cartridge comprising: a master mold component having a cup-shaped body including a first bottom wall and a first annular peripheral side wall, an interior surface of the first bottom wall having a radially outward portion tapered upwardly in a radial inward direction and a flat center section; and a sleeve component having a second bottom wall and a second peripheral side wall shaped to fit within the master mold component, an exterior surface of the second bottom wall having a taper complementary to the radially outward tapered portion of the first bottom wall and a center opening alignable with the flat center section of the master mold component.

In another exemplary but nonlimiting embodiment, there is provided a mold assembly for forming a bottom end cap in a pleated filter cartridge, the assembly comprising: a first outer mold component having a cup-shaped body including a first peripheral side wall and a first bottom wall, the first peripheral side wall having a first interior surface tapering inwardly from a first upper edge to a first inner surface of the first bottom wall; a second inner mold component adapted for mated insertion into the first outer mold component, the second inner mold component having a second peripheral side wall and a second bottom wall, the second peripheral side wall having a second exterior surface tapering inwardly from a second upper edge to a second interior surface of the second bottom wall in a manner complementary to the first interior surface of the first peripheral side wall; the second bottom wall provided with a center opening.

In still another aspect of the disclosure, there is provided a method of molding a bottom end cap within a pleated filter comprising: (a) providing a mold assembly comprising a master mold component having a cup-shaped body including a first bottom wall and a first annular peripheral side wall, an interior surface of the first bottom wall having a radially outward portion tapered upwardly in a radial inward direction and a flat center section; and a sleeve component having a second peripheral side wall and a second bottom wall shaped to fit within the master mold component, an exterior surface of the bottom wall having a taper complementary to the radially outward tapered portion and a center opening alignable with the flat center section; (b) inserting a lower end of a filter into the sleeve component, the filter formed with exterior and interior pleats; (c) introducing a polymer resin, (e.g. polyurethane) into the master mold component to a predetermined fill height; and (d) inserting the filter and sleeve component into the master mold component such that the polymer resin is caused to flow through the center opening in the sleeve component and radially outwardly into the interior pleats on the inside of the pleated filter.

This description of the invention is intended only to provide a general overview of subject matter disclosed herein according to one or more illustrative embodiments, and does not serve as a guide to interpreting the claims or to define or limit the scope of the invention.

### BRIEF DESCRIPTION OF THE DRAWINGS

FIG. 1 is a top perspective view of an exemplary pleated filter cartridge;

FIG. 2 is bottom perspective view of the exemplary pleated filter cartridge of FIG. 1 with a portion of the pleated filter cut away to illustrate the molded bottom end cap;

FIG. 3 is a bottom perspective view of a molded bottom end cap isolated from the pleated filter;

FIG. 4 is a bottom perspective view of an inverted pleated filter with a liner sealed thereto prior to molding the bottom end cap;

FIG. 5 is a side section of a master mold and mold sleeve assembly in accordance with an exemplary but nonlimiting embodiment of the invention;

FIG. 6 is an assembly view in perspective, showing the pleated filter of FIG. 4 prior to insertion into the mold sleeve of FIG. 5; and

FIG. 7 is a partial perspective of the pleated filter and mold sleeve inserted into the master mold.

### DETAILED DESCRIPTION OF THE INVENTION

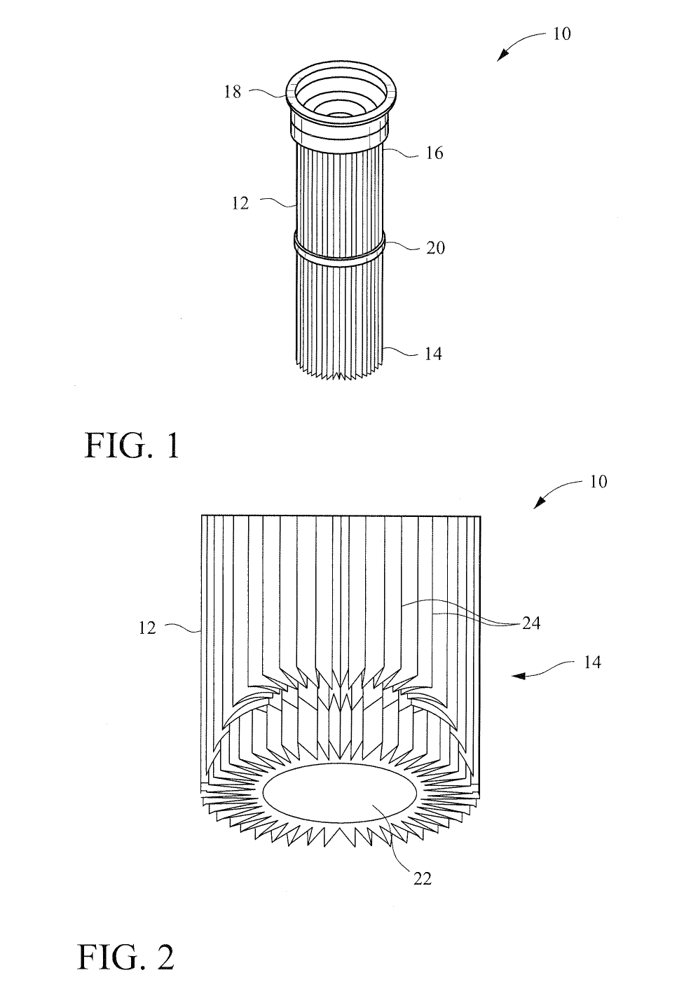

FIG. 1 is a top perspective view of an exemplary pleated filter cartridge 10. The cartridge 10 has an elongated pleated filter 12 which has a bottom end 14 and a top end 16. The top end 16 is provided with a top end cap 18. An external (and optional) support strap 20, formed of any suitable material, may encompass the circumference of the pleated filter 12. The pleated filter 12 may be formed of, for example, 260 gram per square meter spunbond nonwoven material made with bicomponent polyester fibers. Other suitable fiber materials include poly-p-phenylene sulfide (PPS), aramid, polytetrafluoroethylene (PTFE) or glass fibers. Other suitable non-woven constructs include needle-punched felts, carded thermobonds, or hydroentangled webs. These constructs may be stiffened with resin or thermal heat calendaring. In another embodiment, an expanded PTFE (ePTFE) membrane is laminated into the pleated filter 12. The bottom end 14 of the pleated filter 12 is provided with a bottom end cap that is not visible from the perspective of FIG. 1 but is visible in FIG. 2.

FIG. 2 shows a bottom perspective view of the exemplary pleated filter cartridge 10 of FIG. 1 with a portion of the pleated filter 12 cut away to illustrate the molded bottom end cap 22. The molded bottom end cap 22 is formed from a relatively soft molding polymer such as a urethane resin (e.g., a soft polyurethane), which, during the molding process, flows between the interior surfaces of pleats 24 of pleated filter 12. The polyurethane molded bottom end cap 22 does not extend outside the perimeter of the pleated filter 12, and thus no exterior, horizontal edge is present.

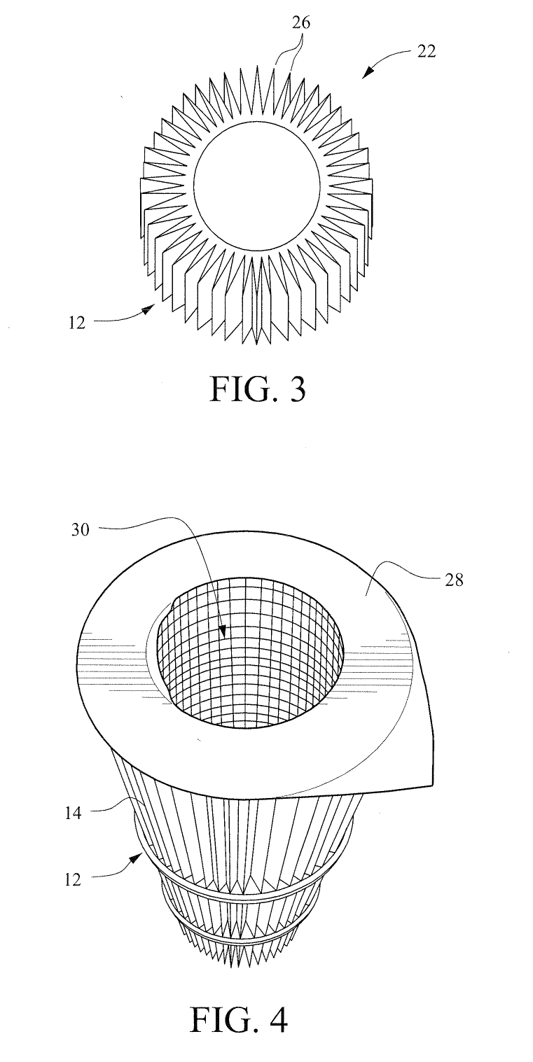

FIG. 3 is a bottom perspective view of the molded bottom end cap 22 isolated from the pleated filter 12. It will be appreciated that the pleats 26 of the end cap 22 correspond to the inner cavity of the pleated filter 12, such that the pleats 26 rest within the pleats 24. The polyurethane bottom end cap 22 also covers the inner cavity of the pleated filter 12. The spaces between the pleats 24, external to the inner cavity, are free of the polyurethane material.

FIG. 4 shows the lower end 14 of the pleated filter 12, with a temporary liner 28 applied over and sealed to the edges of the pleats 24, leaving a center hole or opening 30 to receive the molding material as described below. The liner 28 serves to prevent the urethane material from flowing past the inside perimeter of the pleats. In other words, the liner provides a “floor” at the bottom of the pleat pack, closing the pleats but providing ample space for the urethane to flow through the opening 30 and then radially outwardly into the pleats 24 as described in greater detail below. The liner is removed upon completion of the molding process.

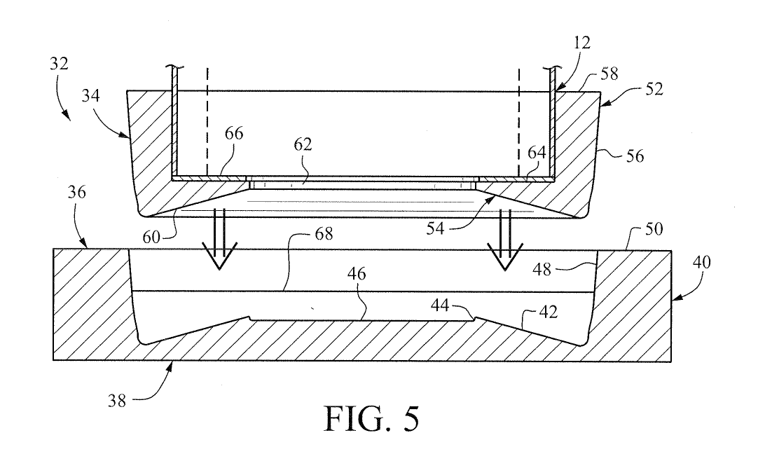

FIG. 5 illustrates a cross section of a mold assembly 32 in accordance with an exemplary but nonlimiting embodiment of the invention. The assembly includes a sleeve 34 and a master mold 36. The master mold 36 has a shallow, cylindrical cup-shape and is provided with a bottom wall 38 and an annular peripheral wall 40. On its exterior, the bottom wall 38 is flat, and the peripheral wall 40 has a uniform outer diameter. On its interior, the bottom wall 38 is formed with an outer portion 42 that tapers upwardly to an annular lip or shoulder 44 that defines a flat center section 46. The interior surface 48 of the peripheral wall 40 tapers outwardly from the bottom wall to the upper peripheral edge 50 of the master mold.

The shallow pan or cup-shaped sleeve 34 is also round, with a peripheral wall 52 and a bottom wall 54. The exterior surface 56 of peripheral wall 52 is tapered inwardly from an upper peripheral edge 58 to the bottom wall 54, and the taper is shaped and sized to permit the sleeve 34 to be received within the master mold 36, with a close fit between the interior surface 48 of the master mold and the exterior surface 56 of the sleeve. The exterior surface 60 of the bottom wall 54 tapers upwardly to a center opening 62, the diameter of which is substantially the same as the diameter of the center section 46 of the master mold. The inside surface 64 of the bottom wall 54 is substantially flat. The tapered surfaces 48 and 56 are substantially complementary such that the sleeve 34 can be substantially fully nested within the master mold 36. The inside diameter of the sleeve peripheral wall 52 is substantially equal to the outside diameter of the pleated filter 12, i.e., the radially outer edges of the pleats 24 fit snugly within the sleeve.

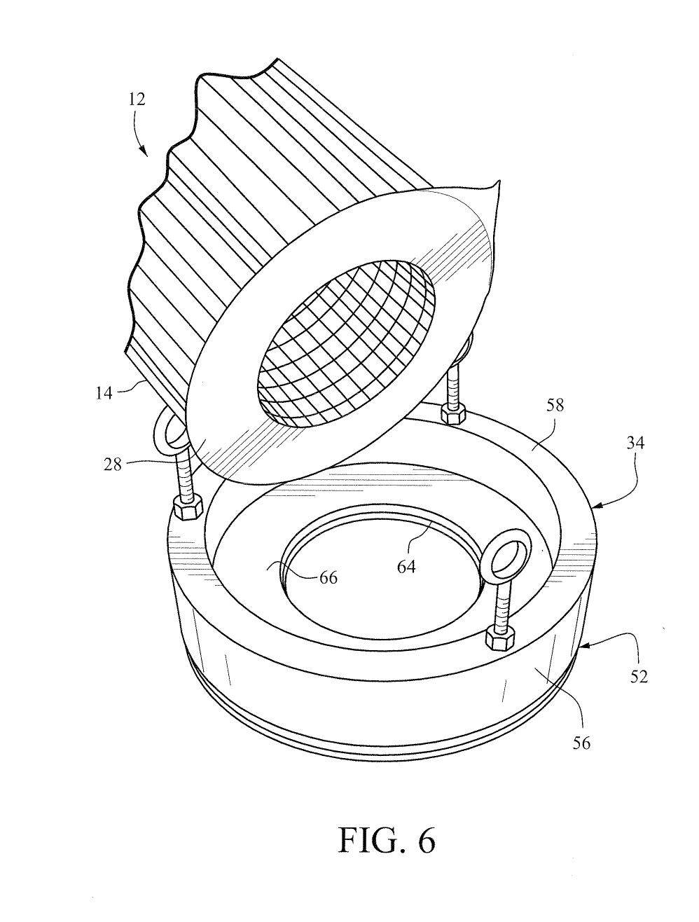

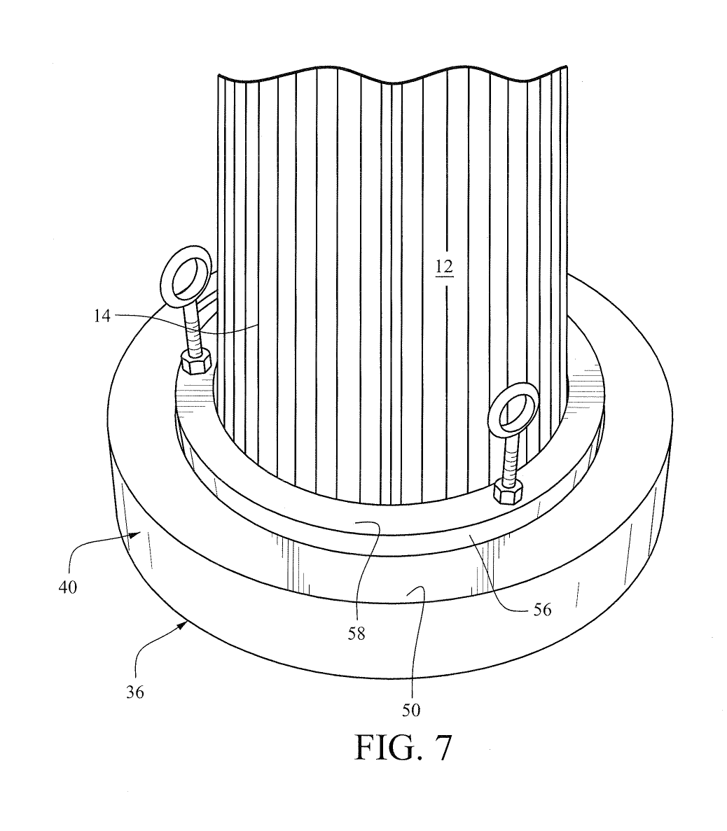

FIG. 6 shows the pleated filter 12, with the liner 28 applied across the bottom of the filter as described in connection with FIG. 4, as it is being inserted into the sleeve 34. Note that a relatively soft, ring-shaped seal 66 is seated on the inside surface 64 to be engaged with the liner 28 and to seal off the bottom of the pleats 24 about the center opening of the pleated filter. FIG. 7 shows the filter and sleeve located within the master mold during the molding process.

More specifically, prior to insertion of the pleated filter (which may have a length up to and exceeding 1 meter) and sleeve into the master mold, the soft urethane resin is introduced into the master mold to a depth indicated by a mold fill line 68 machined about the interior surface 48. The sleeve 34 and pleated filter 12 are then pushed into the master mold, and the urethane resin is forced to flow through the center opening 62 of the sleeve, with radial movement from the center section outwardly into the interior of the pleats 24 to thereby form a star-shaped end cap as shown in FIG. 2. The complimentary tapered surfaces 42 and 60 enhance the flow of material upwardly and radially inwardly, through the opening 62 and then outwardly into the interior of pleats 24, while forming a solid bottom surface on the pleat pack, closing the filter bottom and all the interior pleats to a predetermined depth. The exterior sides of pleats 24 remain open and the now fully-formed bottom end cap exhibits no radially-projecting horizontal edge. The preferred polyurethane hardens and cures in less than five minutes, making it suitable for use in high-speed processes.

It will be appreciated that the dimensions of the master mold 36 and sleeve 34 may vary to accommodate pleated filters having different outside diameters and pleat depths, and that the taper angles of the complementary surfaces 42, 60 may also vary with specific applications.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A mold assembly for forming a bottom end cap in a pleated filter cartridge comprising:
a master mold component having a cup-shaped body including a first bottom wall and a first peripheral side wall, an interior surface of said first bottom wall having a radially outward portion tapered upwardly in a radial inward direction and a flat center section; and
a sleeve component having a second bottom wall and a second peripheral side wall shaped to fit within said master mold component, an exterior surface of said second bottom wall having a taper complementary to said radially outward portion of said first bottom wall, and a center opening alignable with said flat center section of said master mold component.

2. The mold assembly of claim 1 wherein an interior surface of said second bottom wall is substantially flat.

3. The mold assembly of claim 1 wherein said flat center section is recessed from a radially inner edge of said radially outward portion.

4. The mold assembly of claim 1 wherein an inner surface of said first peripheral side wall tapers radially inwardly from an upper edge of said master mold component to said first bottom wall.

5. The mold assembly of claim 1 wherein an outer surface of said second peripheral side wall tapers radially inwardly from an upper edge of said sleeve component to said second bottom wall.

6. The mold assembly of claim 4 wherein an outer surface of said second peripheral side wall tapers radially inwardly from an upper edge of said sleeve component to said second bottom wall.

7. The mold assembly of claim 6 wherein tapers of said inner surface of said first peripheral side wall and said outer surface of said second peripheral side wall are complementary such that said sleeve component is adapted to be received within said master mold in a nested relationship.

8. The mold assembly of claim 1 wherein said flat center section and said center opening have substantially equal diameters.

9. The mold assembly of claim 7 wherein said flat center section and said center opening have substantially equal diameters.

10. A mold assembly for forming a bottom end cap in a pleated filter cartridge, the assembly comprising:
a first outer mold component having a cup-shaped body including a first peripheral side wall and a first bottom wall, said first peripheral side wall having a first interior surface tapering inwardly from a first upper edge to a first inner surface of said first bottom wall;
a second inner mold component adapted for mated insertion into said first outer mold component, said second inner mold component having a second peripheral side wall and a second bottom wall, said second peripheral side wall having a second exterior surface tapering inwardly from a second upper edge to a second interior surface of said second bottom wall in a manner complementary to said first interior surface of said first peripheral side wall; said second bottom wall provided with a center opening.

11. The mold assembly of claim 10 wherein said first bottom wall is provided with a substantially flat center section surrounded by a tapered portion.

12. The mold assembly of claim 10 wherein said first bottom wall is provided with a substantially flat center section, and wherein said center opening and said substantially flat center section having substantially equal diameters.

13. The mold assembly of claim 11 wherein said substantially flat center section is recessed inwardly from said tapered portion of said first bottom wall.

14. The mold assembly of claim 10 wherein said second interior surface of said second bottom wall is substantially flat.

15. The mold assembly of claim 14 including a substantially ring-shaped seal seated on said second interior surface of said second bottom wall, about said center opening.

16. A method of molding a bottom end cap within a pleated filter comprising:
(a) providing a mold assembly comprising a master mold component having a cup-shaped body including a first bottom wall and a first peripheral side wall, an interior surface of said first bottom wall having a radially outward portion tapered upwardly in a radial inward direction and a flat center section; and
a sleeve component having a second peripheral side wall and a second bottom wall shaped to fit within said master mold component, an exterior surface of said second bottom wall having a taper complementary to said radially outward tapered portion and a center opening alignable with said flat center section;
(b) inserting a lower end of a filter into said sleeve component, said filter formed with exterior and interior pleats;
(c) introducing a polymer resin into said master mold component to a predetermined fill height; and
(d) inserting the pleated filter and sleeve component into the master mold component such that the polymer resin is caused to flow through said center opening in said sleeve component and radially outwardly into said interior pleats of said filter.

17. The method of claim 16 wherein, before step (b), a liner is applied over the pleats at the bottom of said pleated filter.

18. The method of claim 16 wherein, before step (b), a seal is located on an interior surface of said second bottom wall.

19. The method of claim 16 wherein said polymer resin comprises polyurethane.

20. The method of claim 19 and further comprising: (e) curing said polyurethane.
